(19) United States
(12) Patent Application Publication
(10) Pub. No.: US 2004/0132930 A1
(43) Pub. Date: Jul. 8, 2004

(54) Polymerisation in aqueous suspension of vinyl chloride

(76) Inventors: Christian Bonardi, Saint-Genis-Laval (FR); Jean-Luc Couturier, Lyon (FR); Sandra Grimaldi, Sainte-Foy-Les-Lyon (FR); Olivier Guerret, Mazerol (FR); Jacques Kervennal, Lyon (FR); Pierre Hebrard, Brignais (FR); Bouchra Taha, Saint-Genis-Laval (FR)

Correspondence Address: Thomas F Roland, Atofina Chemicals Inc, 26th Floor, 2000 Market Street, Philadelphia, PA, 19103-3222, US

(21) Appl. No.: 10/473,891

(22) PCT Filed: Mar. 28, 2002
(86) PCT No.: PCT/FR02/01094

(30) Foreign Application Priority Data
Apr. 2, 2001 (FR) 01 04425

(51) Int. Cl. C08F 2/00

(52) U.S. Cl. 526/82; 526/344; 526/220

(57) ABSTRACT

The invention concerns a method of polymerization in aqueous suspension of vinyl chloride alone or mixed with another vinyl monomer, wherein the initiator comprises at least a compound selected from dialkyl peroxydicarbonates, peroxy-tert-alkanoates and diacyl peroxides, and it consists in using, as short-stopper of the polymerization, a stable free nitroxyl radical. The resulting resins have good whiteness.

The present invention relates to the production of polymers and copolymers based on vinyl chloride by aqueous suspension polymerization of vinyl chloride alone or in a mixture with another vinyl monomer, using a stable radical of nitroxide type as short-stopper.

The expression “aqueous suspension polymerization” is intended to mean a polymerization carried out in the presence of at least one oil-soluble initiator, the monomeric component (vinyl chloride alone or in a mixture with another vinyl monomer) being dispersed by mechanical means in an aqueous medium containing at least one suspending agent.

The proportion of vinyl chloride in the monomeric component is at least 50% by weight, preferably greater than 80%. The vinyl monomers which can be copolymerized in aqueous suspension with vinyl chloride are well known, and non-limiting examples which may be mentioned are vinyl esters, such as vinyl acetate, vinylidene halides, such as vinylidene chloride and vinylidene fluoride, acrylic esters, such as butyl acrylate, and methacrylic esters, such as methyl methacrylate.

The suspending agents generally used in suspension polymerization are known protective colloids, for example water-soluble polymers, such as polyvinyl alcohols, polyethylene oxides, water-soluble cellulose derivatives, such as methylcellulose, polyvinylpyr-rolidone, gelatin and vinyl acetate-maleic anhydride copolymers. These suspending agents may be used alone or in the form of mixtures in amounts generally of between 0.01. and 0.5 parts by weight, preferably of between 0.04 and 0.2 parts by weight, per 100 parts by weight of monomer component.

A system which buffers the pH of the aqueous medium is generally used. The amount used of this system, which is for example citric acid for an acidic pH or sodium hydrogen carbonate for a basic pH, is between 0.01 and 0.2 parts by weight, preferably between 0.02 and 0.1 parts by weight, per 100 parts by weight of monomer component.

The oil-soluble initiator system usually used consists of one or more compounds which generate free radicals which bring about the polymerization of the monomeric component. These free radicals are generally derived from the thermal-decomposition of diacyl peroxides, of dialkyl peroxydicarbonates or of peroxy-tert-alkanoates. The customary industrial method of expressing the amount of initiator(s) introduced into the reaction mixture is to use the overall content of active oxygen capable of being released by the initiator system. The total amounts of active oxygen generally used are between 0.0005 and 0.01 part by weight, preferably between 0.0015 and 0.005 part by weight, per 100 parts by weight of monomeric component. When use is made of a mixture of initiators having different half-life times for a given temperature, the proportion of one with respect to another may range from 1 to 99% by weight, preferably from 10 to 90%. At the same temperature, the more initiator introduced into the reaction medium, the more rapid the reaction. For the same polymerization time, the higher the polymerization temperature, the less initiator remains in the reaction medium.

In an aqueous suspension polymerization process implemented industrially in batch mode, it is generally desirable to terminate the polymerization once a predetermined conversion has been attained, so as to obtain a polymer which is stable and uniform. It can also sometimes be necessary to terminate or slow the reaction during the final phase of polymerization, i.e. when the conversion has attained values of greater than 60% by weight, in order to avoid any final exothermic phenomena which are difficult to control by simple heat exchange at the walls (jacket or condenser), or to terminate the polymerization at short notice if it runs out of control. Agents used for this purpose are referred to as short-stoppers.

The short-stoppers (or killers) most commonly used for aqueous suspension polymerization of vinyl chloride are ATSC (acetone thiosemicarbazone), bisphenol A (4,4′-isopropylidenediphenol), butylhydroxyanisole (BHA) and Irganox® 245 (2,4-dimethyl-6-sec-hexadecylphenol) alone or in a mixture with Irganox® 1076, octadecyl [3-(3,5-di-tert-butyl-4-hydroxy-phenyl)]propionate. Irganox® 1141 (hereinafter referred to as IGX 1141) is a commercial mixture of 80 parts by weight of Irganox® 245 and 20 parts by weight of Irganox® 1076. However, these agents are not entirely satisfactory and there is now a search for compounds which can replace them, which are easier to use (solubility in aqueous medium), and which are at least as effective.

It has now been found that the combination of an initiator system, comprising at least one compound selected from dialkyl peroxydicarbonates, peroxy-tert-alkanoates and diacyl peroxides, and at least one short-stopper selected from stable free radicals of nitroxide type, not only permits effective termination of the polymerization, but can also, and at the same time, give a PVC resin or copolymer resin which provides materials having excellent whiteness. In addition, in comparison with the usual short-stoppers, a reason for selecting the nitroxide is that it has the advantage that it can be immediately diluted in water to useful concentrations without the addition of a stabilizer or a solvent.

A subject of the invention is therefore a process for aqueous suspension polymerization of vinyl chloride alone or in a mixture with less than 50% of another vinyl monomer, characterized in that the polymerization initiator system comprises at least one compound selected from dialkyl peroxydicarbonates, peroxy-tert-alkanoates and diacyl peroxides, and in that at least one short-stopper selected from stable free radicals of nitroxide type is used.

In general, aqueous suspension polymerizations of vinyl chloride or of a monomeric component based on vinyl chloride are carried out at between 45 and 80° C., preferably between 50 and 70° C., and this permits wide use of initiators of the dialkyl peroxydicarbonate family.

In dialkyl peroxydicarbonates, each alkyl radical may contain from 2 to 16 carbon atoms and may be linear, branched or cyclic. Nonlimiting examples of such dialkyl peroxydicarbonates which may be mentioned are diethyl, diisopropyl, di-n-propyl, dibutyl, dicetyl, dimyristyl, di(4-tert-butylcyclohexyl) or di(2-ethylhexyl)peroxydicarbonates. Preference is given to peroxydicarbonates in which each alkyl radical contains from 6 to 16 carbon atoms, and more particularly di(2-ethylhexyl)peroxydicarbonate.

The dialkyl peroxydicarbonates used according to the invention are classified as fast initiators. They generally have a half-life of 1 hour in the region of 56-67° C. and can therefore be used for vinyl chloride polymerization temperatures of between 50 and 70° C.

However, when the polymerization temperature selected is not very high (between 50 and 57° C.), it may prove to be useful to employ a combination of initiators having different half-life times at the selected temperatures, for example containing a dialkyl peroxydicarbonate and a very fast peroxy-tert-alkanoate initiator, or a combination of peroxy-tert-alkanoate initiators comprising one which is fast and one which is very fast.

The very fast peroxy-tert-alkanoates generally have a half-life of one hour in the region of 53-61° C. Nonlimiting examples of very fast peroxy-tert-alkanoate initiators which may be mentioned are 1,1-dimethyl-3-hydroxybutyl peroxyneodecanoate, cumyl peroxyneo-decanoate, 1,1,3,3-tetramethylbutyl peroxyneodecanoate and 1,3-di(2-neodecanoylperoxyisopropyl)benzene.

When the selected polymerization temperature is slightly higher (between 56 and 63° C.), it may prove to be useful to employ a combination of initiators having different half-life times at the selected temperatures, for example containing a dialkyl peroxydicarbonate and a fast peroxy-tert-alkanoate initiator, or a combination of fast peroxy-tert-alkanoates.

The fast peroxy-tert-alkanoates generally have a half-life of one hour at between 61 and 71° C. and can therefore be used for vinyl chloride polymerization temperatures of between 50 and 70° C. Nonlimiting examples of fast peroxy-tert-alkanoates which may be mentioned are tert-butyl peroxyneodecanoate and tert-amyl peroxyneodecanoate.

In the event of a fairly high polymerization temperature (between 62 and 70° C.), it may prove to be useful to employ a combination of initiators having different half-life times at the selected temperatures, for example containing a dialkyl peroxydicarbonate or a fast peroxy-tert-alkanoate and a rather slow diacyl peroxide initiator, such as dilauroyl peroxide, or peroxy-tert-alkanoates such as tert-butyl peroxypivalate.

The short-stopper (or killer) according to the invention is preferably selected from stable free radicals of nitroxide type of formula:

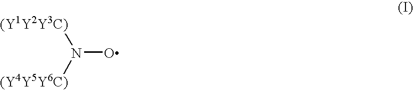

in which the groups Y¹ to Y⁶, which may be identical or different, represent a hydrogen atom, a linear or branched alkyl radical having from 1 to 10 carbon atoms, a cycloalkyl radical having from 3 to 20 carbon atoms, a halogen atom, a cyano radical, a phenyl radical, a hydroxyalkyl radical having from 1 to 4 carbon atoms, a dialkoxyphosphonyl radical, a diphenoxyphosphonyl radical, an alkoxycarbonyl radical or an alkoxycarbonylalkyl radical, or else two or more of the groups Y¹ to Y⁶ may be linked with the carbon atom which bears them so as to form cyclic structures which may comprise one or more extracyclic functions chosen from: HO—, CH₃C(O)—, CH₃O—, H₂N—CH₃C(O)NH—, (CH₃)₂N— and R¹C(O)O— where R¹ represents a hydrocarbon-based radical containing from 1 to 20 carbon atoms; or else may comprise one or more extra- or intracyclic hetero atoms, such as O or N.

By way of illustration of nitroxides (I) which can be used according to the present invention, mention will be made of:

2,2,5,5-tetramethyl-1-pyrrolidinyloxy (generally marketed under the trade mark PROXYL);

3-carboxy-2,2,5,5-tetramethylpyrrolidinyloxy (commonly termed 3-carboxy PROXYL);

2,2,6,6-tetramethyl-1-piperidinyloxy (commonly termed TEMPO);

4-hydroxy-2,2,6,6-tetramethyl-1-piperidinyloxy (commonly termed 4-hydroxy-TEMPO);

4-methoxy-2,2,6,6-tetramethyl-1-piperidinyloxy (commonly termed 4-methoxy-TEMPO);

4-oxo-2,2,6,6-tetramethyl-1-piperidinyloxy (commonly termed 4-oxo-TEMPO);

4-amino-2,2,6,6-tetramethyl-1-piperidinyloxy (commonly termed 4-amino-TEMPO);

4-acetamido-2,2,6,6-tetramethyl-1-piperidinyloxy (commonly termed 4-acetamido-TEMPO);

N-tert-butyl-1-phenyl-2-methylpropyl nitroxide,

N-(2-hydroxymethylpropyl)-1-phenyl-2-methylpropyl nitroxide,

N-tert-butyl-1-diethylphosphono-2,2-dimethylpropyl nitroxide,

N-tert-butyl-1-dibenzylphosphono-2,2-dimethyl-propyl nitroxide,

N-tert-butyl-1-di(2,2,2-trifluoroethyl)phosphono-2,2-dimethylpropyl nitroxide,

N-tert-butyl-[(1-diethylphosphoho)-2-methylpropyl]nitroxide

N-(1-methylethyl)-1-cyclohexyl-1-(diethyl-phosphono)nitroxide,

N-(1-phenylbenzyl)-[(1-diethylphosphono)-1-methylethyl]nitroxide,

N-phenyl-1-diethylphosphono-2,2-dimethylpropyl nitroxide,

N-phenyl-1-diethylphosphono-1-methylethyl nitroxide,

N-(1-phenyl-2-methylpropyl)-1-diethylphosphono-methylethyl nitroxide,

bis(1-oxyl-2,2,6,6-tetramethylpiperidine-4-yl)sebacate marketed -under the trade mark “CXA 5415” by the company CIBA SPEC. CHEM.

These nitroxides may be used as they stand or else in the form of formulations.

According to the present invention, the term “formulation” is intended to mean an aqueous, organic or aquebus/organic composition comprising at least one nitroxide and optionally an organic and/or inorganic additive (NaCl, NaOH, KOH). By way of illustration of organic solvents which can be used in the organic or aqueous/organic compositions, mention will be made of alcohols such as methanol or ethanol.

Use will be made most particularly of 4-hydroxy-TEMPO and N-tert-butyl-1-diethylphosphono-2,2-dimethylpropyl nitroxide.

4-hydroxy-TEMPO is preferably used in the form of a formulation containing a 4-hydroxy-TEMPO content, by weight, ranging from 0.01% to 90%.

The process according to the invention may be used in a manner known per se, consisting, for example, in dissolving a protective colloid in an aqueous medium or a monomeric component, in dispersing the oil-soluble polymerization initiator in the aqueous medium or in dissolving it in the monomeric component, and in dissolving a system for buffering the pH of the aqueous medium. Traces of oxygen are eliminated-so as to have a residual content of oxygen dissolved in the water of between 0.0005 and 0.05 part by weight, preferably of between 0.001 and 0.02 part by weight, per 100 parts by weight of water. The monomeric component is then introduced into the reactor, and the reaction mixture is then stirred and brought to a temperature of between 45 and 80° C., preferably of between 50 and 70° C.

During the polymerization, it is not necessary to maintain constant values for the pressure and the temperature of the reaction mixture. A programmed temperature increase either at the start or at the end of the polymerization cycle allows the decomposition rate of the initiators, and the polymerization rate, to be increased. If this temperature and this pressure are held constant, the polydispersity of the molecular masses of the polymeric chains will be between 1.8 and 2.5. In the case of polymerization with programmed temperature gradients over the entire duration of the polymerization, a polydispersity of between 1.8 and 3.5 will be observed.

The polymerization concludes with a decrease in the concentration of the liquid monomer, the result of this being a change in the monomer vapor/liquid equilibrium, and a pressure drop is observed. The monomer conversion by weight when the pressure drop begins is in the region of 65-75%.

In its role as short-stopper, the nitroxide used according to the invention is introduced at between 60 and 90% conversion by weight, preferably between 70 and 80%, i.e. when the pressure drop has already commenced. The amount of nitroxide used, per 100 parts by weight of monomeric component, may range from 0.0001 to 0.1 part by weight, and is preferably between 0.00015 and 0.01 part by weight.

The nitroxide used according to the invention may be used in combination with other short-stoppers, such as dialkylhydroxylamines, for example diethylhydroxylamine (DEHA).

Once the polymerization has been terminated, the polymer formed is separated from the aqueous medium and then dewatered and dried. It is generally in the form of particles with dimensions of the order of from 80 to 250 micrometers.

In the following examples which illustrate the invention without limiting it, the parts and percentages indicated are expressed by weight unless otherwise mentioned.

### EXAMPLE 1

### Control

14 kg of demineralized water, 2.52 g of citric acid, 3.73 g of polyvinyl alcohol having a degree of hydrolysis of 78 mol %, 3.73 g of polyvinyl alcohol having a degree of hydrolysis of 72 mol %, 8.08 g of an aqueous solution (with 39% of active material) of polyvinyl alcohol having a degree of hydrolysis of 55 mol %, and 13.63 g of an emulsion of di(2-ethylhexyl)peroxydicarbonate with 40% of active material (Luperox® 223 EN40) are introduced, at ambient temperature and with stirring (250 rpm), into a jacketed reactor with a volume of 30 liters, equipped with a 3-arm impeller-type stirrer. The active oxygen content is then 28 ppm, relative to the weight of the vinyl chloride monomer (VCM) which will subsequently be loaded.

Once the reactor has been closed, it is partially evacuated (6.66 kPa absolute) and this pressure is maintained for 15 minutes. The stirring is then brought to 330 rpm and 9 kg of VCM are then introduced.

Heating is regulated by circulating cold water in the jacket to attain the polymerization temperature of 56.5° C. in 30 minutes. The moment at which the polymerization medium attains 56.5° C. is considered to be the onset of polymerization (time=t₀), and the pressure at that juncture (P₀) is then taken as a reference.

After 30 minutes of polymerization (i.e. at time t₀+30 min), 4 kg of water are introduced continuously into the reactor at a constant flow rate of 1.2 kg/h to improve the heat exchange while keeping constant the surface area of the jacket available for heat exchange, and to reduce the viscosity of the aqueous suspension after 60% of conversion of the VCM to PVC, this being the conversion calculated via a calorific balance determined at the limits of the reactor.

The fall in concentration of the VCM gas phase in the reactor results in a pressure drop at between 65 and 70% of conversion. As soon as the pressure has fallen by 1 bar relative to P₀, the polymerization is terminated by rapidly cooling the medium by means of cold water injected into the jacket.

The residual content of di(2-ethylhexyl)peroxydicarbonate is approximately 90 ppm by weight relative to the initial weight of monomer.

The residual VCM is then eliminated from the reaction medium by conventional techniques of restoring atmospheric pressure (degassing) and traces of VCM are then eliminated by degassing under a vacuum of 13.33 kPa at 50° C. (stripping).

The PVC resin thus obtained (K value=67) is then dewatered, dried for 6 hours in a fluidized bed by a current of dry air heated to 50° C. and sieved through a 500 μm mesh.

The method for evaluating the color index of this resin on a pressed plate or WIPP (White Index Pressed Plate) is as follows:

150 g of resin are mixed for 5 minutes at 50 rpm at 96° C., in a 600 ml BRABENDER mixer, with 12 g of a solution of 1 part of dioctyl phthalate in 17 parts of MOK (tin-based heat stabilizer in liquid form marketed by CIBA). The mixture is discharged and, using a WEBER press and not later than during the following 15 minutes, 20 g of the mixture are pressed for 2 minutes at 184° C. and at 300 bar in a mold 70 mm in diameter and 3 mm thick, between two aluminum sheets 0.05 mm thick. The plate obtained is then cooled in water for 45 seconds, and then, during the period from 30 to 90 minutes after pressing, its color is measured using a HUNTERLAB D 25 M DP 9000 device and expressed according to the ASTM standard E 313 in WIPP terms via the formula:

$$WIPP = \frac{L}{100} ( L - 5.7 lb )$$

the values L and b being given by the device.

### EXAMPLES 2 to 4

The procedure is as in example 1, except that, as soon as the pressure drop has attained 0.3 bar (i.e. at P₀-0.3 bar), a 0.04% aqueous solution of 4-hydroxy-TEMPO (4-hydroxy-2,2,6,6-tetramethylpiperidinyloxy, hereinafter referred to as OH-TEMPO) was injected into the reaction medium during the course of 2 minutes, and the reaction medium was kept at 56.5° C. for 15 minutes prior to cooling, the proportion of OH-TEMPO relative to the initial weight of VCM being, respectively, 1.5, 3 and 6 ppm by weight. The degassing, stripping, dewatering, drying and sieving were then carried out in the same way as in example 1, and the PVC resins thus obtained were evaluated in WIPP terms in accordance with the same test.

### EXAMPLE 5

The procedure was the same as in example 1, except that, as soon as the pressure drop attained 0.3 bar (i.e. at P₀-0.3 bar), a 5.35% solution of SG1 (N-tert-butyl-1-diethylphosphono-2,2-dimethylpropyl nitroxide) in methanol was injected into the reaction medium, and the reaction medium was kept at 56.5° C. for 15 minutes before cooling, the proportion by weight of SG1 relative to the initial weight of VCM being 115 ppm. The degassing, stripping, dewatering, drying and sieving were then carried out in the same way as in example 1.

### EXAMPLE 6

The procedure was the same as in example 1, except that, as soon as the pressure drop attained 0.3 bar (i.e. at P₀-0.3 bar), a mixture of OH-TEMPO and of DEHA with 3 ppm and 130 ppm contents by weight, respectively, relative to the initial weight of VCM was injected into the reaction mixture, and the reaction mixture was kept at 56.5° C. for 15 minutes before cooling. The degassing, stripping, dewatering, drying and sieving were then carried out in the same way as in example 1, and the PVC resins thus obtained were then evaluated in WIPP terms in accordance with the same test.

### EXAMPLES 7 and 8

### Comparative

Example 2 was repeated, but replacing the aqueous solution of OH-TEMPO with bisphenol A (BPA) used in the form of a 35% methanolic solution, the proportion of BPA being 370 ppm by weight relative to the initial weight of VCM (example 7), or with Irganox® 1141 (IGX 1141) in the form of an 8% solution in an epoxidized soya oil, the proportion of IGX 1141 being 620 ppm by weight relative to the initial weight of VCM (example 8).

Examples 1 to 8 and their results are summarized in table 1 below.

TABLE 1

| | SHORT-STOPPER | | | | ΔP/Δt | |
|---|---|---|---|---|---|---|
| EXAM- | | weight/ | | | (mbar/ | |
| PLE | type | monomer | | mol | min) | WIPP |
| 1 | none | 0 | | 0 | 40 | 35 |
| 2 | OH-TEMPO | 1.5 | ppm | 0.000078 | 25 | nd |
| 3 | OH-TEMPO | 3 | ppm | 0.000157 | 15 | nd |
| 4 | OH-TEMPO | 6 | ppm | 0.000314 | 0 | 42 |
| 5 | SG1 | 115 | ppm | 0.0035 | 0 | nd |
| 6 | OH-TEMPO/ | 3 | ppm/ | 0.000157/ | 0 | 40 |
| | DEHA | 130 | ppm | 0.0131 | | |
| 7 | BPA | 370 | ppm | 0.0151 | 0 | 46 |
| 8 | IGX 1141 | 620 | ppm | 0.0152 | 3 | 47 |

nd = not determined

The OH-TEMPO functions as short-stopper under the conditions of examples 2 to 4, since the slope of the pressure drop decreases. The polymerization termination effect is obtained for 6 ppm of OH-TEMPO. The resin has high whiteness quality. For SG1, the polymerization termination effect is achieved at contents below 115 ppm.

### EXAMPLE 9

The procedure was the same as in example 1, except that the 13.63 g of an emulsion of di(2-ethylhexyl)peroxydicarbonate with 40% of active material (Luperox® 223 EN40) were replaced with 12.98 g of an emulsion of tert-butyl peroxyneodecanoate (Luperox 10M75) with 40% of active material, and that, when the pressure drop attained 0.3 bar, 50 g of a 0.22% aqueous solution of 4-hydroxy-TEMPO were injected into the reaction medium over a period of 2 minutes, the proportion of OH-TEMPO being 12.5 ppm by weight relative to the initial weight of VCM, and the reaction medium was kept at 56.5° C. for 15 minutes before cooling.

The degassing, stripping, dewatering, drying and sieving were then carried out in the same way as in example 1, and the PVC resin thus obtained was evaluated in WIPP terms in accordance with the same test.

### EXAMPLE 10

The procedure was the same as in example 9, except that 100 g of a 0.03% aqueous solution of 4-hydroxy-TEMPO were used, the proportion of OH-TEMPO being 3 ppm by weight relative to the initial weight of VCM.

The results of examples 9 and 10 are given in table 2 below.

TABLE 2

| | SHORT-STOPPER | | | ΔP/Δt | |
|---|---|---|---|---|---|
| EXAM- | | weight/ | | (mbar/ | |
| PLE | type | monomer | mol | min) | WIPP |
| 9 | OH-TEMPO | 12.5 ppm | 0.00065 | 0 | 52.7 |
| 10 | OH-TEMPO | 3 ppm | 0.000157 | 30 | 53.5 |

### EXAMPLE 11

14 kg of demineralized water, 2.52 g of citric acid, 7.2 g of polyvinyl alcohol having a degree of hydrolysis of 78 mol %, 5.4 g of polyvinyl alcohol having a degree of hydrolysis of 72 mol % and 3.06 g of an aqueous solution (with 39% of active material) of polyvinyl alcohol having a degree of hydrolysis of 55 mol % were introduced, at ambient temperature and with stirring (250 rpm), into a jacketed reactor with a volume of 30 liters, equipped with a 3-arm impeller-type stirrer.

Once the reactor has been closed; it is partially evacuated (6.66 kPa absolute) and this pressure is maintained for 30 minutes. The stirring is then brought to 330 rpm, and 9 kg of VCM are then introduced.

The heating is regulated so as to attain the polymerization temperature of 70° C. (time=t₀) in 45 minutes. At this temperature, 20 g of a solution containing 3.75 g of tert-butyl peroxypivalate (Luperox 11M75) and 16.25 g of isododecane are added.

After 30 minutes of polymerization (i.e. at time t₀+30 min), 3.4 kg of water are introduced continuously into the reactor at a constant flow rate of 1.2 kg/h, to improve heat exchange by keeping constant the surface area of the jacket available for the exchange, and to reduce the viscosity of the aqueous suspension, after 60% conversion of the VCM to PVC, this conversion being calculated via a calorific balance determined at the limits of the reactor.

As soon as the pressure drop has attained 0.3 bar, 50 g of a 0.09% aqueous solution of OH-TEMPO, i.e. 5 ppm by weight of OH-TEMPO relative to the initial weight of VCM, are injected into the reaction medium, and the reaction medium is kept at 70° C. for 15 minutes before cooling.

The degassing, stripping, dewatering, drying and sieving were then carried out in the same way as in example 1.

The ΔP/Δt and WIPP evaluated in accordance with the test described in example 1 are measured. The results are as follows:

ΔP/Δt (mbar/min)=0

WIPP=63.4

### EXAMPLES 12 and 13

### Emergency Termination of the Polymerization

### EXAMPLE 12

500 kg of demineralized water, 90 g of citric acid, 132.5 g of polyvinyl alcohol having a degree of hydrolysis of 78 mol %, 132.5 g of polyvinyl alcohol having a degree of hydrolysis of 72 mol %, 112 g of an aqueous solution (with 39% active material) of polyvinyl alcohol having a degree of hydrolysis of 55 mol % and 166 g of di(2-ethylhexyl)peroxydicarbonate with 75% of active material (Luperox® 223 M 75) were introduced, at ambient temperature and with stirring (125 rpm), into a jacketed reactor with a volume of 1 200 liters, equipped with a 3-arm impeller-type stirrer, and with a nitrogen-pressurized vessel in which there is a killer. The active oxygen content is 18 ppm relative to the weight of VCM which will subsequently be loaded.

Once the reactor has been closed, it is partially evacuated (6.66 kPa absolute) and this pressure is maintained for 30 minutes. The stirring is then brought to 250 rpm, and 320 kg of VCM are then introduced.

The heating is regulated by circulating cold water in the jacket so that the polymerization temperature of 56.5° C. is attained in 30 minutes. The moment when the polymerization medium reaches 56.5° C. is considered to be the onset of polymerization (time=t₀), and the pressure at this juncture (P₀) is then taken as a reference.

After 40 min of polymerization (i.e. at time t₀+40 min), the circulation of cooling water in the jacket is stopped. An increase in pressure and temperature is observed, which is characterized by a ΔP/Δt and ΔT/Δt.

At t₀+45 minutes, 170 g of an aqueous solution of OH-TEMPO with 5.88% by weight of OH-TEMPO contained in the nitrogen-pressurized vessel, i.e. 31 ppm by weight of OH-TEMPO relative to the weight of VCM loaded into the reactor, are introduced.

The variations in temperature and in pressure are recorded and are given in table 3.

### EXAMPLE 13

### Comparative

The procedure is the same as in example 12, except that, at t₀+45, 1.5 l of a methanolic solution with 25% by weight of bisphenol A (BPA), i.e. 1 313 ppm by weight of BPA, relative to the weight of VCM loaded into the reactor, are introduced.

As in example 12, the variations in temperature and in pressure are recorded and are given in table 3 below.

TABLE 3

| | | | | ΔP/Δt | | ΔT/Δt | |
|---|---|---|---|---|---|---|---|
| | | | | (mbar/min) | | (° C./min) | |
| | Killer | | | before | after | before | after |
| Exam- | | weight/ | | addition | | addition | |
| ple | type | monomer | | of killer | | of killer | |
| 12 | OH-TEMPO | 31 | ppm | 60 | 0 | 0.2 | 0 |
| 13 | BPA | 1 313 | ppm | 94 | 3 | 0.3 | 0.03 |

It is noted that OH-TEMPO functions as emergency short-stopper (killer) at a very low content.

1. A process for aqueous suspension polymerization of vinyl chloride alone or in a mixture with less than 50% of another vinyl monomer, characterized in that the polymerization initiator system comprises at least one compound selected from dialkyl peroxydicarbonates, peroxy-tert-alkanoates and diacyl peroxides, and in that at least one short-stopper selected from stable free radicals of nitroxide type is used.

2. The process as claimed in claim 1, in which the short-stopper is selected from nitroxides of formula: 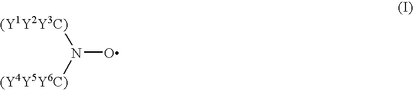
in which the groups Y¹ to Y⁶, which may be identical or different, represent a hydrogen atom, a linear or branched alkyl radical having from 1 to 10 carbon atoms, a cycloalkyl radical having from 3 to 20 carbon atoms, a halogen atom, a cyano radical, a phenyl radical, a hydroxyalkyl radical having from 1 to 4 carbon atoms, a dialkoxyphosphonyl radical, a diphenoxyphosphonyl radical, an alkoxycarbonyl radical or an alkoxycarbonylalkyl radical, or else two or more of the groups Y¹ to Y⁶ may be linked with the carbon atom which bears them so as to form cyclic structures which may comprise one or more extracyclic functions chosen from H₂N—CH₃C(O)NH—, (CH₃)₂N— and R¹C(O)O— where R¹ represents a hydrocarbon-based radical containing from 1 to 20 carbon atoms; or else may comprise one or more extra- or intracyclic hetero atoms, such as O or N.

3. The process as claimed in claim 2, characterized in that the nitroxides are used as they stand or in the form of formulations.

4. The process as claimed in claim 2, characterized in that the short-stopper is 4-hydroxy-2,2,6,6-tetramethyl-1-piperidinyloxy (4-hydroxy-TEMPO).

5. The process as claimed in claims 3 and 4, characterized in that the 4-hydroxy-TEMPO is used in the form of formulations containing a 4-hydroxy-TEMPO content, by weight, ranging from 0.01% to 90%.

6. The process as claimed in claim 2, characterized in that the short-stopper is N-tert-butyl-1-diethylphosphono-2,2-dimethylpropyl nitroxide (SG1).

7. The process as claimed in one of claims 2 to 6, in which the nitroxide is combined with another short-stopper, such as dialkylhydroxylamine.

8. The process as claimed in claim 7, characterized in that the dialkylhydroxylamine is diethylhydroxyl-amine.

9. The process as claimed in claim 1, in which each alkyl radical of the dialkyl peroxydicarbonate contains from 2 to 6 carbon atoms, preferably 6 to 16 carbon atoms.

10. The process as claimed in claim 9, in which the dialkyl peroxydicarbonate is di(2-ethylhexyl)peroxydicarbonate.

11. The process as claimed in claim 1, in which the polymerization initiator system comprises a dialkyl peroxydicarbonate and a very fast peroxy-tert-alkanoate.

12. The process as claimed in claim 11, in which the very fast peroxy-tert-alkanoate is 1,1-dimethyl-3-hydroxybutyl peroxyneodecanoate.

13. The process as claimed in claim 1, in which the polymerization initiator system comprises a dialkyl peroxydicarbonate and a fast peroxy-tert-alkanoate.

14. The process as claimed in claim 1, in which the polymerization initiator system is a mixture of a dialkyl peroxydicarbonate or a fast peroxy-tert-alkanoate with a diacyl peroxide.

15. The process as claimed in claim 14, in which the fast peroxy-tert-alkanoate is tert-butyl peroxyneo-decanoate and the diacyl peroxide is dilauroyl peroxide.

16. The process as claimed in claim 1, in which the polymerization initiator system is a mixture of two fast peroxy-tert-alkanoates or a mixture of a very fast peroxy-tert-alkanoate and a fast peroxy-tert-alkanoate.

17. The process as claimed in claim 16, in which the very fast peroxy-tert-alkanoate is 1,1-dimethyl-3-hydroxybutyl peroxyneodecanoate.

18. The process as claimed in claim 1, in which the polymerization initiator system is a slow peroxy-tert-alkanoate, such as tert-butyl peroxypivalate.

19. The process as claimed in any one of claims 1 to 18, characterized in that the short-stopper is used in a proportion of 0.0001 to 0.1 part by weight per 100 parts by weight of vinyl chloride alone or in a mixture with less than 50% of another vinyl monomer, and preferably in a proportion of 0.00015 and 0.01 part by weight.

20. A polymer and a copolymer based on vinyl chloride, obtained using a process as claimed in one of claims 1 to 19.
